(19) United States
(12) Patent Application Publication
(10) Pub. No.: US 2022/0144493 A1
(43) Pub. Date: May 12, 2022

(54) Bracket for Securing a Bucket

(71) Applicant: Charles W. Brewer, Norfolk, VA (US)

(72) Inventor: Charles W. Brewer, Norfolk, VA (US)

(73) Assignee: Charles W. Brewer, Norfolk, VA (US)

(21) Appl. No.: 17/503,779

(22) Filed: Oct. 18, 2021

Related U.S. Application Data
(60) Provisional application No. 63/112,904, filed on Nov. 12, 2020.

(51) Int. Cl. B65D 25/22; F16M 13/02

(52) U.S. Cl. CPC B65D 25/22; F16M 13/02

(57) ABSTRACT

A bracket for securing a bucket. The bracket includes a longitudinal strip comprising a body with an upper end and a lower end. The upper end has a U-shaped hook extending downward toward a middle portion of the body with a length of at least about ⅕ of a length of the body. The hook is spaced apart, biased toward and substantially parallel in relation to the body. The hook is configured to retain at least an upper portion of a bucket with the distal end of the hook projecting outward to form a tab. The lower end has a lip extending upward and away from the body for supporting a bottom of a bucket. The bucket is mounted onto the bracket by securing it to the lip and is retained on the bracket by the hook.

### CROSS-REFERENCE TO RELATED APPLICATION

This patent application claims the benefit of priority to U.S. Provisional Application No. 63/112,904 filed on Nov. 12, 2020, the disclosure of which is hereby incorporated by reference in its entirety and is made part of this U.S. utility application for all purposes.

### FIELD OF THE INVENTION

### Background

Buckets are commonly used for storing various items and liquids. They are available in a wide variety of configurations and sizes, including one- and five-gallon capacities. A common issue when working with buckets is that they occupy valuable work/foot space and are difficult to reach when placed on the floor. Yet placing buckets on a workbench takes up valuable desk space and makes them cumbersome to use. Thus, what is desired is a system for holding buckets that enables easy access while taking up minimal space.

### Summary

To this end, the present invention is directed to a bracket for securing a bucket onto a vertical surface. The bracket provides easy placement and removal of a bucket, while also remaining secure even when the bucket is filled. The bracket is mounted onto a vertical surface and allows the bucket to be held above ground to increase extra space, particularly foot space in the work area. Moreover, the bracket itself occupies minimal space to further increase the amount of space available in a work area.

Accordingly, one aspect of the present invention is directed to a bracket for securing a bucket in a vertical orientation. The bracket comprises a longitudinal strip comprising a body with an upper end and a lower end. The upper end has a U-shaped hook extending downward toward a middle portion of the body and has a length of at least about ⅕ of a length of the body. The hook is spaced apart and substantially parallel in relation to the body. The hook is biased toward the body and configured to retain at least an upper portion of a bucket. The distal end of the hook projects outward to form a tab. The lower end has a lip extending upward and away from the body that is configured to support a bottom of a bucket. The bucket is mounted onto the bracket by securing it to the lip and is retained on the bracket by the hook.

In some embodiments, a set of holes configured to receive a fastener to mount the longitudinal strip to a vertical surface. For example, the set of holes may include a first hole at the upper end of the body and a second hole overlapping the first hole on the hook, wherein the first and second holes are configured to receive a fastener to mount the upper end to a vertical surface.

These and other aspects will become apparent to those skilled in the art after a reading of the following description of the embodiments when considered with the drawings.

### BRIEF DESCRIPTION OF THE DRAWINGS

FIG. 1 is a top perspective view of a bucket secured onto a bracket according to one embodiment;

FIG. 2 is a front perspective view of a bracket according to one embodiment;

FIG. 3 is a front elevation view of a bracket according to one embodiment;

FIG. 4 is a rear elevation view of the bracket in FIG. 3;

FIG. 5 is a side elevation view of the bracket in FIG. 3;

FIG. 6 is a bottom perspective view of a bucket secured onto a bracket according to one embodiment; and

FIG. 7 is a front perspective view of a bracket according to one embodiment.

### DETAILED DESCRIPTION OF THE EMBODIMENTS

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

All patents, patent applications and publications referred to herein are incorporated by reference in their entirety. In case of a conflict in terminology, the present specification is controlling.

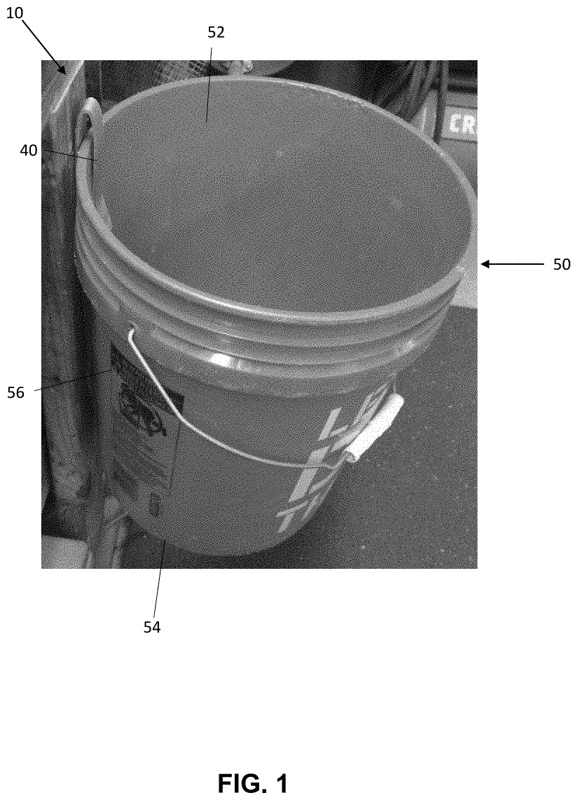

As shown in FIG. 1, a bracket 10 configured to secure a bucket 50 onto a vertical surface 40 is provided. The bracket 10 supports the bucket 50 at its bottom surface 54 and retains the outer wall 56 of the bucket by biasing/retaining the inner wall 52 of the bucket towards the vertical surface 40.

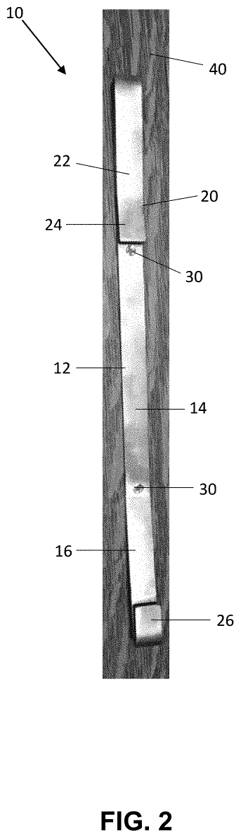

One embodiment of the bracket 10 mounted onto a vertical surface 40 is shown in FIGS. 2-4. In this embodiment, the bracket 10 comprises a longitudinal strip 12 having a body 14 with a lower end 16 and an upper end 20. The lower end 16 includes a lip 26 for supporting the bottom of the bucket 50. The upper end 20 includes a U-shaped hook 22 configured to be inserted into the bucket 50 to maintain the bucket 50 in a vertical position and prevent the bucket from tipping.

In some embodiments, the body 14 may include one or more holes, each configured to receive a fastener, for mounting the longitudinal strip 12 to a vertical surface 40. For example, a first hole 28 may be positioned near or at the upper end 20. In some embodiments, a second hole 29 may be included near or at the lower end 16. Additional holes may be included along the body 14 to further secure the longitudinal strip 12. Other means for mounting the longitudinal strip may include, but are not limited to, hook and loop fasteners, adhesives, snap fits, press fits and other brackets for securing the longitudinal strip onto installed on a vertical surface.

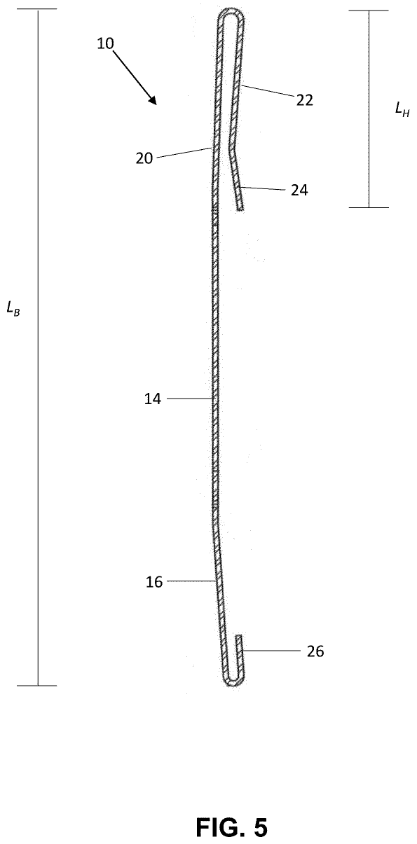

The lower end 16 and upper end 20 may be angled with respect to the longitudinal axis of the body 14. For example, the lower end 16 and upper end 20 may be angled at a direction toward the lip 26 and hook 22, respectively, such that the lower and upper ends are positioned (e.g., leaning) away from the vertical surface 40 when the bracket 50 is mounted. As seen in FIG. 5, the U-shaped hook 22 may be biased back toward the body 14 to assist with retaining the bucket 50 on the bracket.

In some embodiments, the U-shaped hook 22 may include a tab 24. As seen in FIG. 5, the tab 24 may be formed at a distal end of the hook 22, wherein the hook 22 projects away from the body 14 to form the tab 24. The tab 24 may be used to facilitate installation and removal of the bucket 50 from the hook 22 and bracket 10. Yet other embodiments of the U-shaped hook 22 may not include a tab 24.

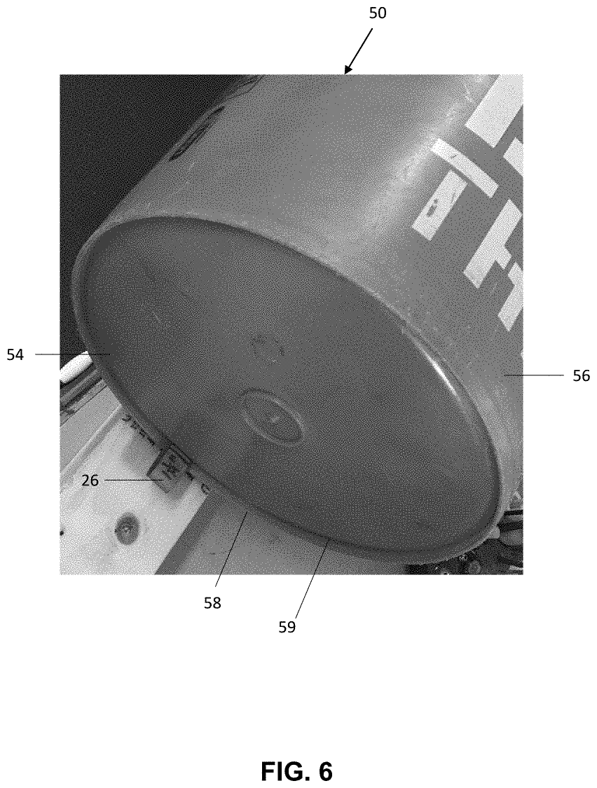

In some embodiments, the lower end includes a lip 26 for supporting a bucket 50. As seen in FIG. 6, the lip 26 may support the bucket 50 by securing the outer rim 58 on the bottom of the bucket. The lip 26 may be inserted into a groove 59 of the bucket so that the outer rim 58 is secured between the lip 26 and the body 12. However, other embodiments of the bracket 10 may include a lower end 16 having a platform for supporting the bottom of the bucket 50. For example, the platform may be substantially flat and oriented perpendicularly to the body 12. Another example may include a lip wherein the distal end is a platform such that the lip supports the bucket bottom's flat surface instead of being inserted into a groove.

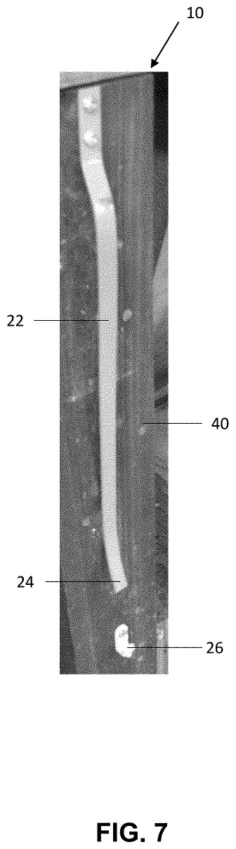

The hook 22 and the lip 26 may be formed from the longitudinal strip such that the bracket 10 is comprised of a single body. In the embodiment shown in FIG. 5, the upper end 20 is curved to form a U-shaped hook 22 and the lower end 16 is curved to form the lip 26. However, in some embodiments, the bracket 10 may be comprised of multiple pieces. For example, as seen in FIG. 7, the hook 22 and/or the lip 26 may be separate components. For example, the lip 26 may be a separate platform individually mounted onto the vertical surface for supporting the bucket and the hook 22 may be installed above the lip 26 for retaining the bucket 50 in an upright position.

Yet preferably, the bracket 10 is provided as one-piece. The shape of the bracket 10, with the bending of the body 12 at the upper and lower ends to form a hook and lip, causes the bucket 50 and bracket 10 to interact and respond in a manner that facilitates the bucket's attachment, with the bottom surface 54 of the bucket snapping into place. The shape and angle of the upper hook 22 causes the bottom surface 54 of the bucket to be forced downward, thereby being caught by the lip 26 with minimal downward pressure. The bucket 50 is removed by counteracting the natural pressure the bracket 10 exerts on the bucket. For example, a slight pull (e.g, approximately ¼ inches) on the bottom of the bucket 50 in a downward direction is sufficient to remove the bucket from the bracket 10. The two counteracting bends of the body (upper hook 22 and lower lip 26) causes the bucket 50 to maintain a vertical position parallel to the bracket 10 even when weight is added to the bucket.

The overall size of the bracket may vary depending on the type of bucket intended for use. By way of example, the distance between hook 22 and lip 26 may vary to accommodate different bucket sizes, which may be accomplished in some instances by varying the length of the body 14. In some embodiments, the body 12 may include a means for adjusting its length to accommodate a variety of bucket sizes. For example, the body 12 may have a telescoping means for extending or contracting its length to vary the distance between the hook 22 and lip 26.

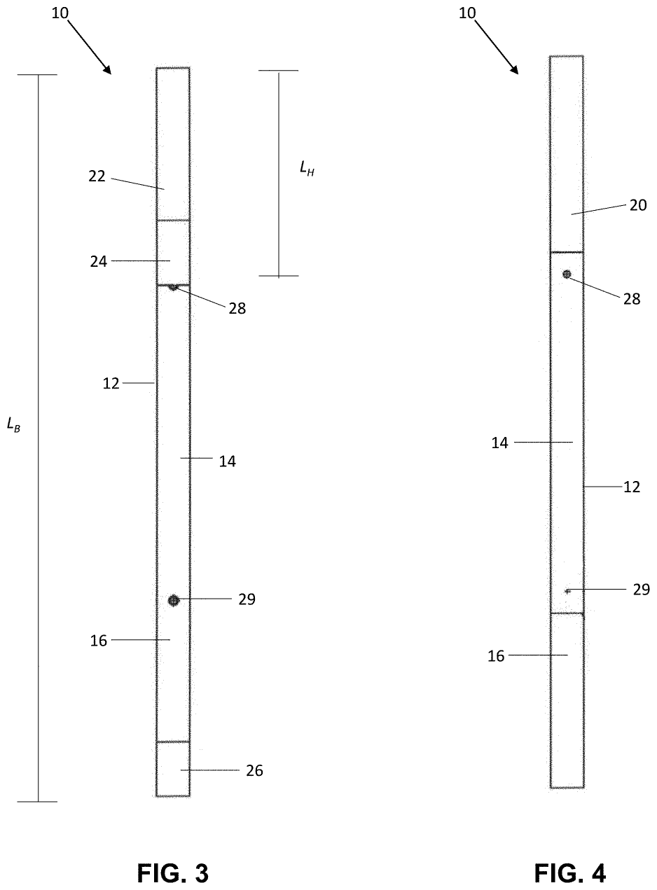

The stability of the bucket 50 while secured by the bracket 10 may be dependent upon the length of the upper hook 22 that extends into the bucket. A hook that extends too shallow into the bucket may cause the bucket to easily tip over, while a hook that extends too deep into the bucket may be more difficult to remove from the bracket 10. Thus, in some embodiments wherein the bracket 10 comprises a single longitudinal strip, the length of the hook L_{H} may preferably be about ¼ to about ½ of the length of the body L_{B}, and more preferably, may be about ¼ of the length of the body as seen in FIGS. 3 and 5. For instance, the total length of the body L_{B} may preferably be about 16 inches and the length of the hook L_{H} may preferably be about 5 inches to accommodate a five-gallon bucket.

In operation, a bucket 50 is secured by the bracket 10 by placing the bucket's outer wall 56 at the body 12 and raising the bucket so that the hook 22 is inserted into the bucket whereby the upper portion of the bucket 50 is secured between the upper end 20 of the bracket and the hook 22. The bucket 50 is supported by the bracket 10 by placing the bottom of the bucket 50 onto the lip 26, such that the outer rim 58 on the bottom of the bucket is secured between the lower end 16 and the lip 26. The bucket 50 may be easily removed by lifting the bucket from the lip 26 then lowering the bucket 50 away from the bracket 10 to remove the hook 22 from the bucket.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

That which is claimed is:

1. A bracket for securing a bucket in a vertical orientation comprising:
a longitudinal strip comprising a body with an upper end and a lower end,
the upper end having a U-shaped hook extending downward toward a middle portion of the body and having a length of at least about ⅕ of a length of the body, the hook spaced apart and substantially parallel in relation to the body, the hook biased toward the body and configured to retain at least an upper portion of a bucket, a distal end of the hook projecting outward to form a tab; and
the lower end having a lip extending upward and away from the body, the lip configured to support a bottom of a bucket,
wherein the bucket is mounted onto the bracket by securing it to the lip and is retained on the bracket by the hook.

2. The bracket of claim 1 further including a set of holes configured to receive a fastener to mount the longitudinal strip to a vertical surface.

3. The bracket of claim 2, wherein the set of holes comprises a first hole at the upper end of the body and a second hole overlapping the first hole on the hook, the first and second holes configured to receive a fastener to mount the upper end to a vertical surface.

4. The bracket of claim 1, wherein the upper end is curved to form the U-shaped hook.

5. The bracket of claim 1, wherein the lower end is curved to form the lip.

6. The bracket of claim 1, where the length of the hook is between about ¼ to about ½ of the length of the body.
